(19) United States
(12) Patent Application Publication
(10) Pub. No.: US 2016/0209042 A1
(43) Pub. Date: Jul. 21, 2016

(54) INSULATED FIREBRICK OVEN FOR WOOD, CHARCOAL, GAS OR OTHER BIOMASS MATERIALS

(71) Applicant: Julian G. YU, (US)

(72) Inventor: Julian G. YU, Quezon City (PH)

(21) Appl. No.: 14/392,057

(22) PCT Filed: May 22, 2013
(86) PCT No.: PCT/PH2013/000012

§ 371 Date: Jul. 13, 2015

(30) Foreign Application Priority Data
Jan. 25, 2013 (PH) 2-2013-000022

(51) Int. Cl. F24B 1/195; F24C 1/02; F24B 1/182; A21B 1/52; F24B 1/20

(52) U.S. Cl. CPC F24B 1/195; A21B 1/52; F24B 1/207; F24B 1/182; F24C 1/02

(57) ABSTRACT

This invention relates to an insulated firebrick oven adapted for using wood, charcoal, gas or other biomass materials for cooking bread, cookies, roasted meat, pizzas and the like that includes a moveable stand having an anchoring member; and a combustion chamber assembly removably held on top of said anchoring member and having an insulated firebrick food compartment provided with a chimney and an inside heat balancer, and further having a slidably mounted pull-out firebox provided with a pull-out ash tray.

Unlike conventional ovens, subject invention has a firebrick wall that could facilitate fast cooking in addition for its perforated firebrick as its fuel. It has further an adjustable air vent that could regulate the needed temperature.

### FIELD OP THE INVENTION

This invention relates in general to ovens and more particularly to an insulated firebrick oven adapted for using wood, charcoal, gas or other biomass materials for cooking bread, cookies, roasted meat, pizzas and the like.

### BACKGROUND OF THE INVENTION

There are a number of existing ovens nowadays, which uses woods, charcoals and others as fuel. Mostly these ovens appear in different shapes and forms to satisfy the needs of the user in terms of convenience of use and portability as well. However, experience dictates that although it satisfies the use, a need is seen to exist where the oven could provide economical use of the fuel using charcoal, gas or any biomass materials.

Furthermore, during the use of the conventional oven using woods regulating the amount of heat needed is sometimes complicated that the user has to add or reduce the amount of said fuel manually from time to time during cooking period.

A need therefore exist to remedy the aforementioned drawbacks.

### OBJECTS OF THE INVENTION

It is therefore the principal object of subject invention to remedy the aforementioned drawbacks by providing for a firebrick insulated oven having insulated firebrick side and bottom walls that minimize heat loss on oven's body and concentrate heat on the food where it is needed using charcoals, gas and other biomass.

Another object of subject invention is to provide for an insulated firebrick oven having an adjustable air vent that regulates the required heat needed.

Still another object of subject invention is to provide for a insulated firebrick oven having a pull-out fire box with an integrated ash tray that could be conveniently cleaned as desired.

Yet, another of subject of subject invention is to provide for a insulated firebrick oven having a perforated firebrick plate that could achieve optimum air/fuel mixture for efficient combustion resulting in fuel savings, minimizes smoke emission and ash accumulation. It will not melt, corrode or rust even after repeated cooking

Other objects and advantages of subject invention will come to light upon reading the following description taken in conjunction with the appended drawings wherein:

### BRIEF DESCRIPTION OF THE SEVERAL VIEWS OF THE DRAWINGS

FIG. 1 is a perspective view of an insulated firebrick oven embodying subject invention with an opened door and pulled firebox;

FIG. 2 is a side view of thereof; and

FIG. 3 is an exploded view of FIG. 2 showing the moveable stand as separated from the combustion chamber assembly.

### DETAILED DESCRIPTION OF THE INVENTION

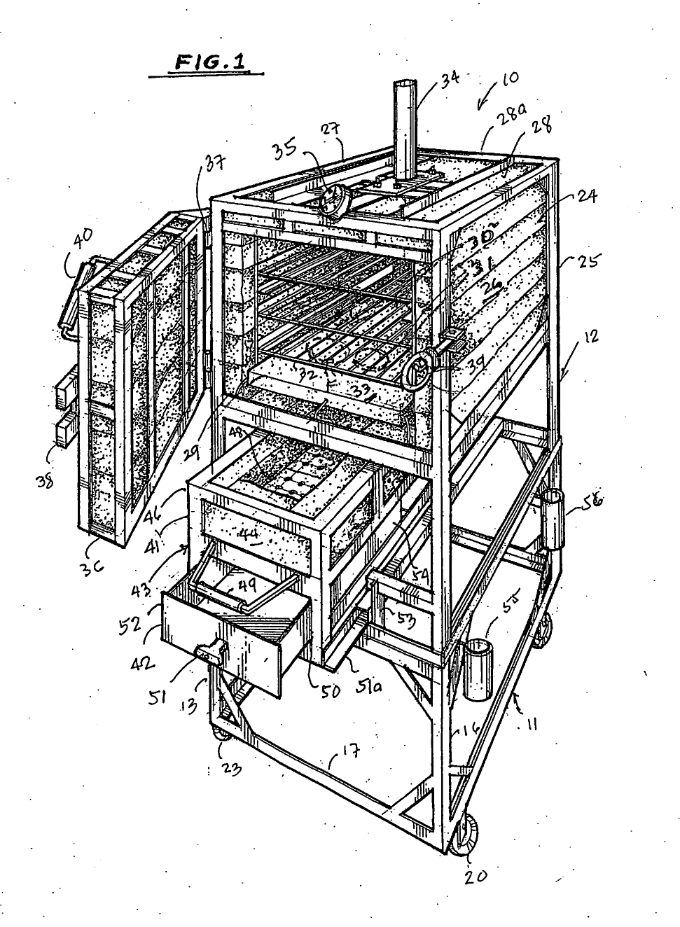

Referring now to the drawings in detail, wherein like numerals designate same parts throughout, there is shown particularly in FIG. 1, an insulated firebrick oven adapted for using wood, charcoal, gas or other biomass materials for cooking bread, cookies, roasted meat, pizzas and the like generally designated as 10, which includes a moveable stand 11 and a combustion chamber assembly 12 removably held on top of said moveable stand 11.

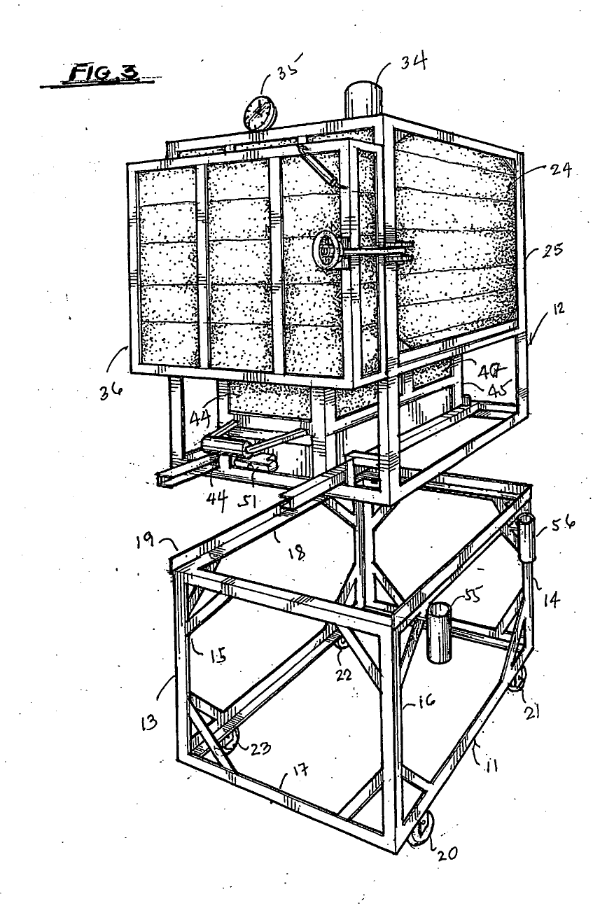

As shown particularly in FIG. 3, said moveable stand 11 is defined by a rectangular shaped frame having a front portion 13, rear 14, left 15, right 16, bottom 17 and top 18. The top portion 18 is provided with anchoring member 19 defined by an L-shaped like channel. Its bottom portion 17 is provided with spacedly disposed wheels 20,21,22 and 23 for portability purposes.

The combustion chamber assembly 12 that is removably held on top of said moveable stand 11 by means of said anchoring member 19, has an insulated firebrick food compartment 24 being defined by a rectangular frame 25 provided inside with firebrick side walls 26, 27, 28, 28a, and an opened front portion 29. Inside said food compartment 24 are spacedly disposed food holders 30, 31, and 32. And an inside heat balancer 33 defined by a rectangular shaped refractory brick adapted to keep the balance of heat inside. On top of this food compartment 24 is a centrally disposed chimney 34 and adjacent thereto is a thermometer 35 for watching the needed required temperature for cooking the food F inside. An insulated firebrick door 36 is detachably mounted on one of its longitudinal edge by means of hinges 37 and having a female lock 38 while, a male lock 39 is provided at the other longitudinal edge. An inclinedly oriented handle 40 is used to conveniently open and closed this door 36.

Beneath this food compartment 24 is the combined slidably mounted pull-out firebox 41 and ash-tray 42 which are enclosed in a rectangular frame 43. This pull-out firebox 41 which is defined by a rectangular body is provided with firebrick front wall 44, rear wall 45 (shown in FIG. 3), left side wall 46 (shown in FIG. 1) and right side wall 47. It is opened at the top, to where a removably mounted rectangular shaped perforated fire brick 48 is freely held inside. A broad handle 49 is provided at the front of said pull-out firebox 41 for its convenient retrieval as desired.

This ash-tray 42, which is preferably made of stainless steel material is disposed beneath said pull-out firebox 41 and slidably mounted along the opening 50 and provided with a ceramic handle 51 for its easy access as desired.

The rectangular frame 43 is provided along its both longitudinal edges with opposed guide members 51a and 52 being defined by opposed longitudinal flanges; which are in communication with the a safety hatch 53 of the said combustion chamber assembly 12 being defined by an angular frame adapted to prevent said firebox 41 from falling out. And to regulate the desired temperature within this firebox 41 an adjustable air vent 54 is provided at the sides of said ash tray 42.

In use, as shown in FIG. 1, the door 36 is opened and the firebox 41 is made to be ready for cooking through the perforated brick 48 using fuels such as wood, charcoal, gas or other biomass materials. Then, this firebox 41 it is pushed forward in proper alignment with that of the food compartment 24. The amount of air is regulated by manipulating said adjustable air vent 54 as desired. Then the food F (shown for illustrative purposes only) such as bread, cookies, roasted meat, pizzas and the like, is placed on the holders 30,31, and 32.

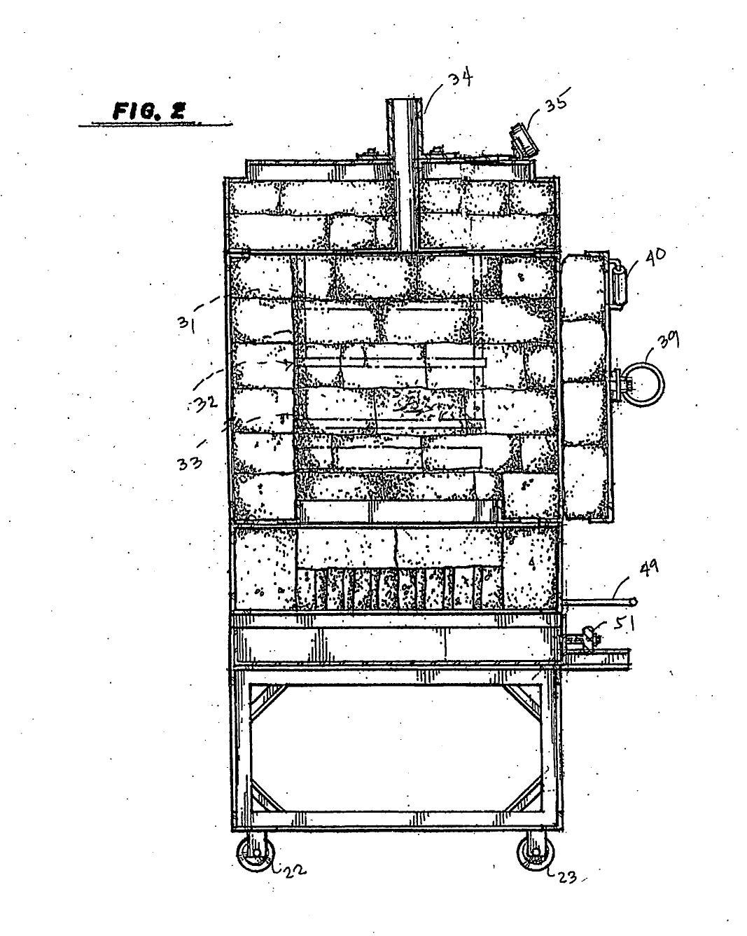

After the food F is cook said firebox 41 can be pulled outward through the broad handle 49. The ash tray 42 can be pulled also outward by means of its handle 51 to get rid of dirt materials such as ashes and the like. Consequently, the door 36 could be closed as shown in FIG. 2 for the succeeding use.

A pair of opposed accessory handles 55, 56 is secured at the longitudinal sides of said moveable stand 11 adapted for handling accessory tools or equipment used for cooking.

These entire oven 10 or stand itself could be moved on a desired location conveniently by means of the wheels 20, 21, 22 and 23.

1. An insulated firebrick oven adapted for using wood, charcoal, gas or other biomass materials for cooking bread, cookies, roasted meat, pizzas and the like, comprising:
a moveable stand having an anchoring member; and
a combustion chamber assembly removably held on top of said anchoring member and having an insulated firebrick food compartment provided with a chimney and an inside heat balancer, and further having a slidably mounted pull-out firebox provided with a pull-out ash tray.

2. An insulated firebrick oven adapted for using wood, charcoal, gas or other biomass materials for cooking bread, cookies, roasted meat, pizzas and the like in accordance with claim 1, wherein said insulated firebrick food compartment is provided on its top with a thermostat.

3. An insulated firebrick oven adapted for using wood, charcoal, gas or other biomass materials for cooking bread, cookies, roasted meat, pizzas and the like in accordance with claim 1, wherein said heat balancer is defined by a refractory firebrick.

4. An insulated firebrick oven adapted for using wood, charcoal, gas or other biomass materials for cooking bread, cookies, roasted meat, pizzas and the like in accordance with claim 1, wherein the opposed longitudinal sides of said pull-out ash tray is provided with an adjustable air vent.

5. An insulated firebrick oven adapted for using wood, charcoal, gas or other biomass materials for cooking bread, cookies, roasted meat, pizzas and the like in accordance with claim 1, wherein said firebox is provided with a perforated firebrick.
